(19) United States
(12) Patent Application Publication
(10) Pub. No.: US 2011/0315319 A1
(43) Pub. Date: Dec. 29, 2011

(54) PRE-CLEAN CHAMBER WITH REDUCED ION CURRENT

(75) Inventors: JOHN C. FORSTER, Mt. View, CA (US); TAE HONG HA, San Jose, CA (US); MURALI K. NARASIMHAN, San Jose, CA (US); XINYU FU, Fremont, CA (US); ARVIND SUNDARRAJAN, San Jose, CA (US); XIAOXI GUO, Saratoga, CA (US)

(73) Assignee: APPLIED MATERIALS, INC., Santa Clara, CA (US)

(21) Appl. No.: 13/166,213

(22) Filed: Jun. 22, 2011

Related U.S. Application Data
(60) Provisional application No. 61/358,701, filed on Jun. 25, 2010.
(60) Provisional application No. 61/365,636, filed on Jul. 19, 2010.

(51) Int. Cl. B08B 5/00

(52) U.S. Cl. 156/345.29

(57) ABSTRACT

Apparatus for processing substrates are disclosed herein. In some embodiments, a substrate processing system may include a process chamber having a first volume to receive a plasma and a second volume for processing a substrate; a substrate support disposed in the second volume; and a plasma filter disposed in the process chamber between the first volume and the second volume such that a plasma formed in the first volume can only flow from the first volume to the second volume through the plasma filter. In some embodiments, the substrate processing system includes a process kit coupled to the process chamber, wherein the plasma filter is disposed in the process kit.

### CROSS-REFERENCE TO RELATED APPLICATIONS

This application claims benefit of U.S. provisional patent application Ser. No. 61/358,701, filed Jun. 25, 2010, and U.S. provisional patent application Ser. No. 61/365,636, filed Jul. 19, 2010, which are herein incorporated by reference.

### FIELD

Embodiments of the present invention generally relate to substrate processing systems.

### BACKGROUND

Substrate processing systems, such as plasma preclean chambers, may be used to clean a substrate prior to a processing step. For example, the substrate may be processed prior to entering the plasma preclean chamber, for example, by an etching process, an ashing process or the like. The substrate may enter the plasma preclean chamber with residues, such as etch residues, oxides, or the like that may need to be removed without damaging the substrate. The inventors have observed that conventional preclean chambers may generate damage on some substrates, for example, on sub-65 nm dielectric films.

Accordingly, the inventors have provided an improved preclean chamber.

### SUMMARY

Apparatus for processing substrates are disclosed herein. In some embodiments, a substrate processing system may include a process chamber having a first volume to receive a plasma and a second volume for processing a substrate; a substrate support disposed in the second volume; and a plasma filter disposed in the process chamber between the first volume and the second volume such that a plasma formed in the first volume can only flow from the first volume to the second volume through the plasma filter. In some embodiments, the substrate processing system includes a process kit coupled to the process chamber, wherein the plasma filter is disposed in the process kit.

In some embodiments, a substrate processing system includes a process chamber having a first volume and a second volume; a substrate support disposed in the second volume; a ring having a first outer edge configured to rest on a wall of the process chamber and having a first inner edge; a body extending downward from the first inner edge of the ring, the body having sidewalls defining a opening above the substrate support; a lip extending from the sidewalls of the body into the opening above the substrate support; and a plasma filter having a peripheral edge supported by a second inner edge of the lip such that a plasma formed in the first volume can only pass through the plasma filter to flow from the first volume to the second volume.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts schematic view of a substrate processing system in accordance with some embodiments of the present invention.

FIG. 2 depicts a perspective view of a plasma filter of a substrate processing system in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Apparatus for processing substrate are disclosed herein. Embodiments of the inventive apparatus may advantageously reduce ion current in a plasma used to clean a substrate disposed in the apparatus. For example, reduced ion current may advantageously be used to remove contaminants, such as etch residues, oxides, or the like, without damaging the substrate. Embodiments of the inventive apparatus may be utilized to clean suitable substrates having contaminants, for example, such as a substrate having a low-k dielectric material that has been etched to form trenches, vias, or the like, in the low-k dielectric material. For example, a substrate may be cleaned in the inventive apparatus to remove etch residues, oxides or the like to expose a metal surfaces prior to back end of line (BEOL) processing to form the metal interconnect structures.

In a non-limiting example, embodiments of the present invention may be utilized for cleaning advanced interconnect structures having porous ultra low k (ULK) dielectrics to enhance product performance by reducing parasitic capacitance. Due to high carbon content, the ULK dielectric may be more sensitive to plasma treatment. In some embodiments, the ULK dielectric may have a dielectric constant of about 2.5 or less. Embodiments of the present invention may be utilized to clean substrates at any suitable device node, such as, but not limited to, about 40 nm or below.

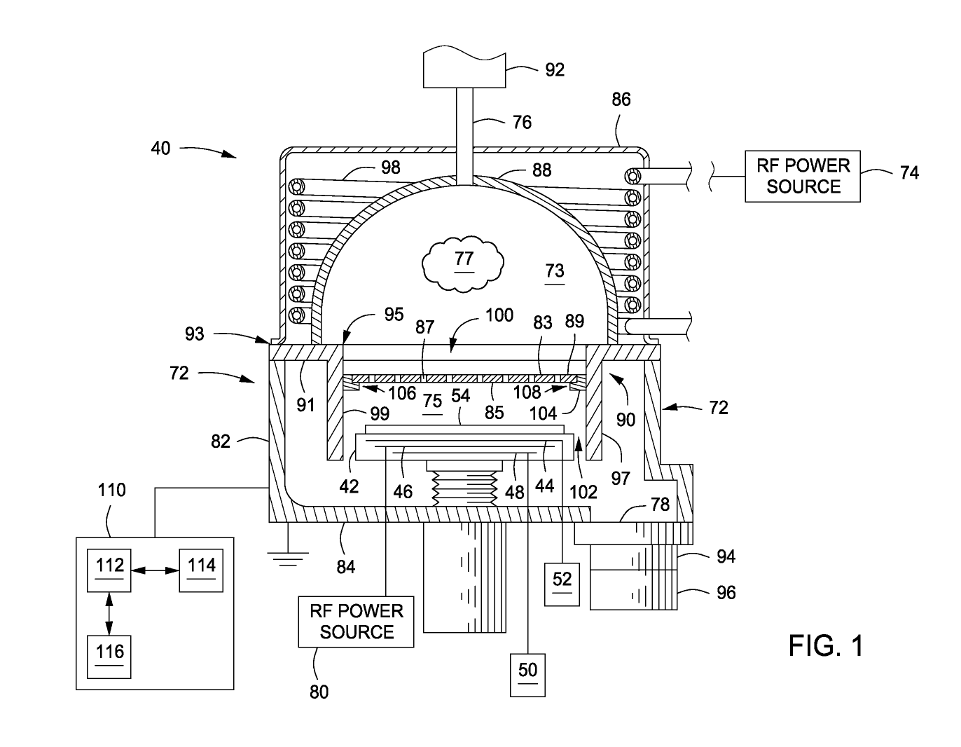

FIG. 1 depicts a substrate processing system in accordance with some embodiments of the present invention. For example, in some embodiments, the substrate processing system may be a pre-clean chamber, such as a Preclean II chamber available from Applied Materials, Inc., of Santa Clara, Calif. Other process chambers may also be modified in accordance with the teachings provided herein. Generally, a substrate processing system 40 comprises a process chamber 72 having a first volume 73 and a second volume 75. The first volume 73 may include a portion of the process chamber 72 where a plasma 77 is to be received (e.g., introduced or formed). The second volume 75 may include a portion of the process chamber 72 where a substrate is to be processed with reactants from the plasma 77. For example, a substrate support 42 may be disposed within the second volume 75 of the process chamber 72. A plasma filter 89 may be disposed in the process chamber 72 between the first volume 73 and the second volume 75 such that the plasma 77 formed in the first volume 73 (or reactants formed from the plasma 77) can only reach the second volume 75 by passing through the plasma filter 89.

The substrate processing system 40 may include a gas inlet 76 coupled to the process chamber to provide one or more processes gases that may be utilized to form a plasma 77 in the first volume. A gas exhaust 78 may be coupled to the process chamber 72, for example in a lower portion of the chamber 72 including the second volume 75. In some embodiments, an RF power source 74 may be coupled to an inductive coil 98 to generate the plasma 77 within the process chamber 72. Alternatively, (not shown), the plasma may be generated remotely, for example, by a remote plasma source or the like, and flowed into the first volume 73 of the process chamber. In some embodiment, a power source 80 may be coupled to the substrate support 42 to control ion flux to a substrate 54 when present on a surface of the substrate support 42. The substrate processing system 40 may include a controller 110, for example, to control one or more components of the substrate processing system 40 to perform operations on the substrate 54. Other and further components and substrate processing system 40 are discussed below.

The process chamber 72 includes walls 82, a bottom 84 and a top 86. A dielectric lid 88 may be disposed under the top 86 and above a process kit 90, the process kit 90 coupled to the process chamber 72 and configured to hold the plasma filter 89. The dielectric lie 88 may be dome-shaped as illustrated in FIG. 1. The dielectric lid 88 be made from dielectric materials such as glass or quartz, and is typically a replaceable part that may be replaced after a certain number of substrates have been processed in the system 88. The inductive coil 98 may be disposed about the dielectric lid 88 and coupled to an RF power source 74 to inductively couple RF power to the first volume 75 to form the plasma 77 in the first volume 73. Alternatively to or in combination with the inductive coil 98, a remote plasma source (not shown) may be used to form the plasma 77 in the first volume 73 or to provide the first plasma 77 to the first volume 73.

The process kit 90 may include a ring 91, such as a flange, having a first outer edge 93 configured to rest on the wall 82 of the process chamber 72. For example, as shown in FIG. 1, the ring 91 may rest on the wall 82 and have the dielectric lid 88 and the top 86. However, the embodiments illustrated in FIG. 1 are merely exemplary, and other embodiments are possible. For example, the ring may be configured to rest on an internal feature of the chamber (not shown), such as a lip extending inward from the wall 82 or the like. The ring 91 may further include a first inner edge 95.

The process kit 90 may include a body 97 extending downward from the first inner edge 95 of the ring 91. The body 97 may include sidewalls 99 which define an opening 100 above the substrate support 42. For example, as illustrated in FIG. 1, the diameter of the opening 100 may exceed the diameter of the substrate support 42. For example, a gap 102 formed between the substrate support 42 and the sidewalls 99 of the body 97 may be utilized as a flow path for process gases, byproducts, and other materials to be exhausted to the exhaust 78.

The process kit 90 may include a lip 104 extending from the sidewalls 99 of the body 97 into the opening 100 above the substrate support 42. The lip 104 may be configured to hold the plasma filter 89 as discussed below. The lip 104 may extend from the sidewalls 99 of the body 97, for example, such as from a position along the sidewalls 99 below the ring 91 as illustrated in FIG. 1. Alternatively, the lip 104 may extend from the body 97 proximate the position of the ring 91, such at a level about even with the ring 91. The lip 104 may extend from the body 97 at any suitable position, such that the plasma filter 89 may be below the plane of the induction coil 98 to prevent interference with the inductive coupling, and to prevent any stray plasma from being generated below the plasma filter 89.

The lip 104 may have a second inner edge 106 configured to support a peripheral edge of the plasma filter 89 on the second inner edge 106. For example, the second inner edge 106 may include a recess 108 disposed about the second inner edge 106 to hold the plasma filter 89 in the recess 108. However, the recess 108 is merely one exemplary embodiment for holding the plasma filter 89 and other suitable retaining mechanisms may be utilized.

The process kit 90 may comprise any suitable materials compatible with processes being run in the system 40. The components of the process kit 90 may contribute to defining the first and second volumes 73, 75. For example, the first volume 73 may be defined by at least the ring 91, the lip 104, the plasma filter 89, and the dielectric lid 88. For example, in some embodiments, such as illustrated in FIG. 1, the first volume 73 may be further defined by the sidewalls 99 of the body 97. For example, the second volume 75 may be defined by the lip 104, the plasma filter 89, the body 97, and the substrate support 42.

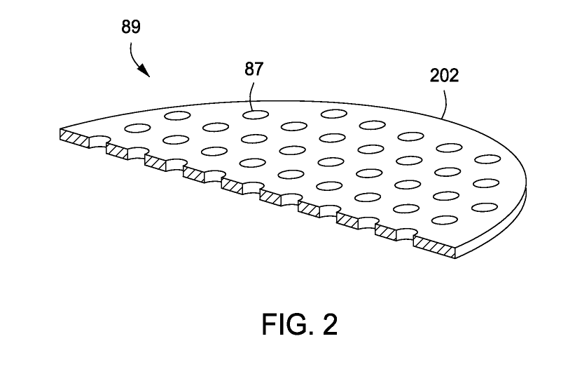

FIG. 2 depicts a perspective view of the plasma filter 89 in accordance with some embodiments of the present invention. In some embodiments, the plasma filter 89 comprises a plate 202 having a plurality of openings 87 disposed through the plasma filter 89 from a first volume facing surface 83 of the plasma filter 89 to a second volume facing surface 85 of the plasma filter 89. The plurality of openings 87 fluidly couple the first volume 73 to the second volume 75. The plate 202 may be fabricated of a dielectric material such as quartz or other materials compatible with process chemistries. In some embodiments, the plate 202 could comprise a screen or a mesh wherein the open area of the screen or mesh corresponds to the desired open area provided by the apertures 87. Alternatively, a combination of a plate and screen or mesh may also be utilized.

The plasma filter 89 may be used to limit the ion current of the plasma 77 after the plasma 77 is formed in the process chamber. For example, the ion current of the plasma 77 may be tailored to a desired ion current by controlling one or more aspects of the plasma filter 89. For example, the plurality of openings 87 may vary in size, spacing, and/or geometric arrangement across the surface of the plate 202. For example, the number of openings 87 in the plurality of openings may be selected to be sufficient to reduce the ion current in the plasma 77 as the plasma 77 moves from the first volume 73 to the second volume 75. The size of the openings 87 generally range from 0.03 inches (0.07 cm) to about 3 inches (7.62 cm). The openings 87 may be arranged to define an open area in the surface of the plate 202 of from about 2 percent to about 90 percent. In some embodiments, the one or more openings 87 includes a plurality of approximately half-inch (1.25 cm) diameter holes arranged in a square grid pattern defining an open area of about 30 percent. It is contemplated that the holes may be arranged in other geometric or random patterns utilizing other size holes or holes of various sizes. The size, shape and patterning of the holes may vary depending upon the desired ion density in the second volume 75. For example, more holes of small diameter may be used to increase the radical to ion density ratio in the second volume 75. In other situations, a number of larger holes may be interspersed with small holes to increase the ion to radical density ratio in the second volume 75. Alternatively, the larger holes may be positioned in specific areas of the plate 202 to contour the ion distribution in the second volume 75.

Alternatively, or in combination, and for example, the positioning of each opening 87 on the plasma filter 89 may be selected for a similar purpose. For example, the positioning may be selected to correspond with the density of the plasma 77, such as if the plasma 77 were to have a higher ion density proximate the center and a lower ion density proximate the sheath of the plasma 77. For example, any such non-uniformity in the plasma 77 (if one existed) could be accounted for, such as by having a higher density of openings proximate the center of the plasma filter 89 and a lower density proximate the edge of the plasma filter 89. Accordingly, the density of openings 87 in the plurality of openings 87 may be selected to be sufficient to reduce the ion current in the plasma 77 as the plasma 77 moves from the first volume 73 to the second volume 75.

Other aspects of the plasma filter 89 may be used to adjust the ion current of the plasma 77. Alternatively, or in combination with aspects discussed above, and for example, the diameter of each opening 87 in the plurality of openings 87 may be selected to be sufficient to reduce the ion current in the plasma 77 as the plasma 77 move from the first volume 73 to the second volume 75. For example, the openings 87 may limit the ion current which can reach the second volume 75, if the diameter of each opening 87 is less than the sheath width of the plasma 77. Alternatively, or in combination with aspects discussed above, and for example, the thickness of the plasma filter 89 may be adjusted, such as to change the length of each opening 87 to control ion current in the plasma 77. The openings 87 may allow radicals and other neutral gas species to reach the second volume 75 and enable processing of a substrate present on the substrate support 42. Further, the plasma filter 89 may be placed sufficiently far above the substrate support 42, either by location of the lip 104 and/or by position of the surface of the substrate support 42 relative to the plasma filter 89 to allow diffusion to smear out any impact of a pattern of the plurality of openings 87 on a substrate disposed on the substrate support 42.

Returning to the system 40, the gas inlet 76 is connected to a processing gas supply 92 and introduces the processing gas into the system 40 during processing. As illustrated, the gas inlet 76 is coupled to the first volume 75 via the dielectric lid 88. However, the gas inlet 76 may be coupled into the first volume 75 at any suitable location. The gas exhaust 78 may comprises a servo control throttle valve 94 and a vacuum pump 96. The vacuum pump 96 evacuates the system 40 prior to processing. During processing, the vacuum pump 96 and the servo control throttle valve 94 maintain the desired pressure within the system 40 during processing. In some embodiments, the process gas may comprise one or more of hydrogen (H₂), helium (He), or the like. In some embodiments, the process gas comprises a mixture of H₂ and He, wherein H₂ is about 5%.

The substrate support 42 generally includes one or more of a heater 44, an RF electrode 46, and a chucking electrode 48. For example, the RF electrode 46 may comprise titanium and may be connected to a power source 80 to provide an RF bias during processing. The use of bias power to the RF electrode 46 may aid in plasma ignition and/or control of ion current. However, bias power from the RF electrode 46 may not be compatible with all embodiments of the system 40. Accordingly, plasma ignition must be achieved by other means in such cases. For example, at sufficiently high pressure (depending on gas type), the capacitive coupling between the inductive coil 98 and the first volume 73 can enable plasma ignition.

The substrate support 42 may include the chucking electrode 48 to secure the substrate 54 when disposed on the substrate support to the surface of the substrate support 42. The chucking electrode 48 may be coupled to a chucking power source 50 through a matching network (not shown). The chucking power sources 50 may be capable of producing up to 12,000 W at a frequency of about 2 MHz, or about 13.56 MHz, or about 60 Mhz. In some embodiments, the chucking power source 50 may provide either continuous or pulsed power. In some embodiments, the chucking power source may be a DC or pulsed DC source.

The substrate support may include the heater 44 to heat the substrate 54 when disposed on the substrate support 42 to a desired temperature. The heater 44 may be any type of heater suitable to provide control over the substrate temperature. For example, the heater 44 may be a resistive heater. In such embodiments, the heater 44 may be coupled to a power source 52 configured to provide the heater 44 with power to facilitate heating the heater 44. In some embodiments, the heater 44 may be disposed above or proximate to the surface of the substrate support 42. Alternatively, or in combination, in some embodiments, the heaters may be embedded within the substrate support 42. The number and arrangement of the heater 44 may be varied to provide additional control over the temperature of the substrate 54. For example, in embodiments where more than one heater is utilized, the heaters may be arranged in a plurality of zones to facilitate control over the temperature across the substrate 54, thus providing increased temperature control.

The controller 110 comprises a central processing unit (CPU) 112, a memory 114, and support circuits 116 for the CPU 112 and facilitates control of the components of the system 40 and, as such, methods of processing a substrate in the system 40. The controller 110 may be one of any form of general-purpose computer processor that can be used in an industrial setting for controlling various chambers and sub-processors. The memory, or computer-readable medium, 114 of the CPU 112 may be one or more of readily available memory such as random access memory (RAM), read only memory (ROM), floppy disk, hard disk, or any other form of digital storage, local or remote. The support circuits 116 are coupled to the CPU 112 for supporting the processor in a conventional manner. These circuits include cache, power supplies, clock circuits, input/output circuitry and subsystems, and the like. The memory 114 stores software (source or object code) that may be executed or invoked to control the operation of the system 40 in the manner described herein. The software routine may also be stored and/or executed by a second CPU (not shown) that is remotely located from the hardware being controlled by the CPU 112.

In an example of operation, the substrate 54 is positioned on the substrate support 42, and the system 40 is evacuated to provide a vacuum processing environment. A processing gas is introduced through the gas inlet 76 into the first volume 73. To activate the reaction, a plasma of the processing gas is generated in the processing region through inductive coupling and/or capacitive coupling. The initial plasma 77 may be generated by applying power to the inductive coil 98. During the reduction reaction period, the inductive coil 98 may be biased between about 0.0032 W/cm² and about 3.2 W/cm² at between about 100 KHz and about 60 MHz to sustain a plasma in the processing region inductively while the substrate support 42 is biased between about 0 W/cm² and about 0.32 W/cm² to sustain the plasma capacitively. Alternatively, during the reduction reaction period, the plasma 77 in the processing region may be sustained solely by the inductive coil 98. It is contemplated that the plasma within the processing region may be excited and sustained during processing by inductive coupling only, capacitive coupling only or combinations of both inductive and capacitive coupling. Alternatively, the initial plasma may be struck by biasing the substrate support 42 between about 0.0032 W/cm² and about 0.32 W/cm², which corresponds to a RF power level between about 1 W and about 100 W for a 200 mm substrate, and between about 100 KHz and about 100 MHz for about 3 seconds.

The chamber pressure may initially be built up to the desired processing pressure by setting the servo control throttle valve 94 to a partially closed state. During processing, the chamber pressure may be maintained between about 5 mTorr and about 100 mTorr by controlling the open/closed state of the servo control throttle valve 94. Optionally, the temperature of the substrate 54 during processing is controlled by the heater 44 within the substrate support 42.

In one exemplary embodiment, where the plasma filter 89 was about 0.75 inches above the substrate 54, the ion current with and without the plasma filter 89 was measured as a function of pressure. The process gas used was a 5% H₂ in He mixture. The RF power source 74 was set at about 750 Watts to provide power to the inductive coil 98 to facilitate plasma ignition. The presence of the plasma filter 89 was found reduced the ion current by a factor of about 100 to about 1000 over a pressure range of about 0 to about 100 mTorr.

As discussed above, ion current may be affected by the size and number of the openings 87 in the plasma filter 89, however other tuning knobs such as pressure, RF power, or the like. For example, in some embodiments, pressure may be used to change ion current by factor of about 4 to about 5. RF power may be used as a tuning knob, but may be limited by plasma stability. For example, in some embodiments, power provided by the RF power source 74 may be less than about 550 W to maintain plasma stability. For example, in some embodiments, pressure may be less than about 100 mTorr to maintain plasma stability.

Thus, an improved apparatus for processing substrates has been provided herein. Embodiments of the inventive apparatus may advantageously reduce ion current in a plasma used to clean a substrate disposed in the apparatus with reduced damage to surfaces of the substrate or to materials disposed thereon.

While the foregoing is directed to embodiments of the present invention, other and further embodiments of the invention may be devised without departing from the basic scope thereof.

1. A substrate processing system, comprising:
a process chamber having a first volume to receive a plasma and a second volume for processing a substrate;
a substrate support disposed in the second volume; and
a plasma filter disposed in the process chamber between the first volume and the second volume such that a plasma formed in the first volume can only flow from the first volume to the second volume through the plasma filter.

2. The substrate processing system of claim 1, further comprising:
a process kit coupled to the process chamber, wherein the plasma filter is disposed in the process kit.

3. The substrate processing system of claim 2, wherein the process kit further comprises:
a ring having a first outer edge configured to rest on a wall of the process chamber and having a first inner edge;
a body extending downward from the first inner edge of the ring, the body having sidewalls defining a opening above the substrate support; and
a lip extending from the sidewalls of the body into the opening above the substrate support, the lip having a second inner edge configured to support a peripheral edge of the plasma filter on the second inner edge of the lip.

4. The substrate processing system of claim 3, wherein the second volume is defined by the lip, the plasma filter, the body, and the substrate support.

5. The substrate processing system of claim 3, further comprising:
a dielectric lid disposed above the process kit.

6. The substrate processing system of claim 5, wherein the first volume is defined by at least the ring, the lip, the plasma filter and the dielectric lid.

7. The substrate processing system of claim 5, wherein the dielectric lid is dome-shaped.

8. The substrate processing system of claim 7, further comprising:
an inductive coil disposed about the dome-shaped dielectric lid to couple RF power to the first volume to form a plasma in the first volume.

9. The substrate processing system of claim 1, wherein the plasma filter further comprises:
a plurality of openings disposed through the plasma filter from a first volume facing surface of the plasma filter to a second volume facing surface of the plasma filter, wherein the plurality of openings fluidly coupled the first volume to the second volume.

10. The substrate processing system of claim 9, wherein the number of openings in the plurality of openings is sufficient to reduce the ion current in a plasma as the plasma moves from the first volume to the second volume.

11. The substrate processing system of claim 9, wherein the density of openings in the plurality openings is sufficient to reduce the ion current in a plasma as the plasma moves from the first volume to the second volume.

12. The substrate processing system of claim 9, wherein a diameter of each opening in the plurality of openings is sufficient to reduce the ion current in a plasma as the plasma moves through each opening from the first volume to the second volume.

13. The substrate processing system of claim 1, wherein the plasma filter comprises quartz.

14. The substrate processing system of claim 1, wherein the substrate support further comprises:
a heater to heat a substrate when disposed on the substrate support to a desired temperature.

15. The substrate processing system of claim 1, wherein the substrate support further comprises:
a chucking electrode to secure a substrate when disposed on the substrate support to a surface of the substrate support.

16. A substrate processing system, comprising:
a process chamber having a first volume and a second volume;
a substrate support disposed in the second volume;
a ring having a first outer edge configured to rest on a wall of the process chamber and having a first inner edge;
a body extending downward from the first inner edge of the ring, the body having sidewalls defining a opening above the substrate support; and
a lip extending from the sidewalls of the body into the opening above the substrate support; and
a plasma filter having a peripheral edge supported by a second inner edge of the lip such that a plasma formed in the first volume can only pass through the plasma filter to flow from the first volume to the second volume.

17. The substrate processing system of claim 16, further comprising:
a dome shaped dielectric lid disposed above the ring, wherein the first volume is defined by at least the ring, the lip, the plasma filter and the dielectric lid and the second volume is defined by the lip, the plasma filter, the body, and the substrate support.

18. The substrate processing system of claim 17, further comprising:
an inductive coil disposed about the dome-shaped dielectric lid to couple RF power to the first volume to form a plasma in the first volume.

19. The substrate processing system of claim 16, wherein the plasma filter further comprises:
a plurality of openings disposed through the plasma filter from a first volume facing surface of the plasma filter to a second volume facing surface of the plasma filter, wherein the plurality of openings fluidly coupled the first volume to the second volume.

20. The substrate processing system of claim of claim 19, wherein a diameter of each opening in the plurality of openings is sufficient to reduce the ion current in a plasma as the plasma moves through each opening from the first volume to the second volume.
